(19) United States
(12) Patent Application Publication
(10) Pub. No.: US 2026/0147768 A1
(43) Pub. Date: May 28, 2026

(54) System For Extracting Relevant Passages As Context For Multimodal Queries

(71) Applicant: Google LLC, Mountain View, CA (US)

(72) Inventors: Belinda Luna Zeng, Cupertino, CA (US); Andrew Cleveland Loomis, San Mateo, CA (US); Vibhuti Mahajan, Los Angeles, CA (US); Sundeep Vaddadi, Los Gatos, CA (US); Dounia Berrada, Saratoga, CA (US); Rajan Sharad Patel, Los Altos, CA (US); Nicholas Rickman Solichin, Fremont, CA (US); Tara Elizabeth McIntosh, Los Altos Hills, CA (US); Harshit Kharbanda, Pleasanton, CA (US); Louis Wang, San Francisco, CA (US)

(21) Appl. No.: 18/959,367

(22) Filed: Nov. 25, 2024

(51) Int. Cl. G06F 16/2457; G06F 16/9535; G06F 16/9538

(52) U.S. Cl. CPC G06F 16/24578; G06F 16/9535; G06F 16/9538

(57) ABSTRACT

The present disclosure provides computer-implemented methods, systems, and devices for responding to a multimodal input query. A computing device receives a multimodal input query. The computing device receives a plurality of search results from a search engine based on the multimodal input query. The computing device processes the multimodal input query and the plurality of search results with a passage-scoring model to generate a result score for each respective search result. The computing device selects a subset of search results based on based on the result score for each respective search result. The computing device generates a model input comprising the selected subset of search results and the multimodal input query. The computing device processes the model input with a response generation model to generate a model output. The computing device processes transmits the model output for display at a user computing device.

### FIELD

The present disclosure relates generally to generative large language models. More particularly, the present disclosure relates to a system that identifies relevant passages to provide context for use when responding to a multimodal input query using a generative large language model.

### BACKGROUND

As the capability of large language machine-learned models to generate content in response to prompts continues to increase, it can be challenging to ensure that the machine-learned models can generate output that does not include incorrect information or is not responsive to a prompt. This is especially true when the input to the large language model is multimodal. As a result, it is important to provide accurate context to enable the machine-learned models to produce accurate output without unduly increasing the cost of producing the output.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can be performed by a computing system comprising one or more processors. The one or more operations comprise steps for processing multimodal input queries. The operations comprise receiving, by a computing system, a multimodal input query, wherein the multimodal input query comprises image content. The operating comprise receiving, by the computing system, a plurality of search results from a search engine based on the multimodal input query. The operating comprise processing, by the computing system, the multimodal input query and the plurality of search results with a passage-scoring model to generate a result score for each respective search result in the plurality of search results, wherein the passage-scoring model comprises a machine-learned multimodal model configured to simultaneously process both the image content from the multimodal input query and textual content from each respective search result to generate the result score for each respective search result. The operating comprise selecting, by the computing system, a subset of search results from the plurality of search results based on based on the result score for each respective search result in the plurality of search results. The operating comprise generating, by the computing system, a model input comprising the selected subset of search results and the multimodal input query. The operating comprise processing, by the computing system, the model input with a response generation model to generate a model output based on the model input. The operating comprise transmitting, by the computing system, the model output for display at a user computing device.

Another example aspect of the present disclosure is directed to a computing system for processing multimodal input queries. The system can include one or more processors and one or more non-transitory computer-readable media that collectively store instructions that, when executed by the one or more processors, cause the computing system to perform operations. The operations can include receiving a multimodal input query, wherein the multimodal input query comprises image content. The operations further comprise receiving a plurality of search results from a search engine based on the multimodal input query. The operations further comprise processing the multimodal input query and the plurality of search results with a passage-scoring model to generate a result score for each respective search result in the plurality of search results, wherein the passage-scoring model comprises a machine-learned multimodal model configured to simultaneously process both the image content from the multimodal input query and textual content from each respective search result to generate the result score for each respective search result. The operations further comprise selecting a subset of search results from the plurality of search results based on based on the result score for each respective search result in the plurality of search results. The operations further comprise generating a model input comprising the selected subset of search results and the multimodal input query. The operations further comprise processing the model input with a response generation model to generate a model output based on the model input. The operations further comprise transmitting the model output for display at a user computing device.

Another example aspect of the present disclosure is directed to one or more non-transitory computer-readable media that collectively store instructions that, when executed by one or more computing devices, cause the one or more computing devices to perform operations. The operations can include receiving a multimodal input query, wherein the multimodal input query comprises image content. The operations further comprise receiving a plurality of search results from a search engine based on the multimodal input query. The operations further comprise processing the multimodal input query and the plurality of search results with a passage-scoring model to generate a result score for each respective search result in the plurality of search results, wherein the passage-scoring model comprises a machine-learned multimodal model configured to simultaneously process both the image content from the multimodal input query and textual content from each respective search result to generate the result score for each respective search result. The operations further comprise selecting a subset of search results from the plurality of search results based on based on the result score for each respective search result in the plurality of search results. The operations further comprise generating a model input comprising the selected subset of search results and the multimodal input query. The operations further comprise processing the model input with a response generation model to generate a model output based on the model input. The operations further comprise transmitting the model output for display at a user computing device.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 represents an example of a system for selecting passages as context for a generative model in response to a multimodal input query in accordance with example embodiments of the present disclosure;

FIG. 2 depicts a query response system in accordance with example embodiments of the present disclosure;

FIG. 3 depicts a query response system in accordance with example embodiments of the present disclosure;

FIG. 4 depicts an example client-server environment according to example embodiments of the present disclosure;

FIG. 5 depicts an example client-server environment according to example embodiments of the present disclosure;

FIG. 6 is a flow diagram representing a process for identifying relevant passages for context to a generative model in accordance with example embodiments of the present disclosure;

FIG. 7 is a block diagram of an example processing flow for using machine-learned model(s) 1 to process input(s) 2 to generate output(s) 3;

FIG. 8 is a block diagram of an example implementation of an example machine-learned model configured to process sequences of information;

FIG. 9 is a block diagram of an example technique for populating an example input sequence 8;

FIG. 10 is a block diagram of an example computing device 98 that performs according to example embodiments of the present disclosure; and

FIG. 11 is a block diagram of an example computing device 99 that performs according to example embodiments of the present disclosure.

Reference numerals that are repeated across plural figures are intended to identify the same features in various implementations.

### DETAILED DESCRIPTION

Generally, the present disclosure is directed towards a query response system that can improve responses to multimodal input queries by identifying relevant passages and providing those passages as context to a sequence processing machine-learned model. The added context can improve the accuracy of the sequence processing machine-learned model when generating a response to the multimodal input query. When a query response system receives a multimodal input query, the query response system can identify a plurality of relevant passages to use as context for a sequence processing machine-learned model. The passages can be extracted from a plurality of search results associated with the multimodal input query. The query response system can access two or more search systems to generate the plurality of search results (e.g., an image search system and a text-based search system). These search results (or specific passages extracted from the search results) can be provided to a passage-scoring model. The passage-scoring model can generate a relevance score for each passage. The passages with the highest relevance score can be included in the model input (along with the multimodal input query) and provided to a response generation model. The response generation model can produce a model output based on the model input. The model output can be a natural language text that responds to the multimodal input query.

For example, a user query can be an image of a building and a text query. The text query can read, “What year was this building built?” The query response system can use a search engine or other system to identify a plurality of relevant documents to the query and the image. For example, based on the image, the query response system can generate an embedding representing one or more building features. That embedding can be used to identify other pictures of that building and other documents in a searchable database. A list of documents can be retrieved either from a database or the web, and the query response system can identify relevant passages from each document. A passage-scoring model can then score each passage to determine its relevance to the query and the image. For example, passages that describe the specific building in the image and talk about the date it was built may be rated higher than passages that contain only one portion of this information or neither. A plurality of passages can be selected and passed into the sequence processing machine-learned model along with the input query and the image. The sequence processing machine-learned model can generate a natural language response indicating the name of the building and the date it was built. This information can be displayed to a user on a webpage with other search results.

More particularly, a query response system can provide responses to input queries submitted via a computer network. In some examples, the responses can include one or more search results, each search result including a link to a web page or other document. In some examples, the search results can include a natural language response to the input query. In some examples, the input query can be multimodal. A multimodal input query can be an input query that includes two types of content. In general, the input query can include two or more of: textual content (e.g., a natural language question), speech content (e.g., captured audio of a user's speech), and one or more media elements (e.g., an image, a video, a piece of audio content, and so on).

In existing systems, if an input query was multimodal, a search service could convert one or more media elements into a textual representation. The textual representation could be a generated description of the contents of the image or another textual representation of the image (or other media content). However, converting the image into text requires an extra step, which can be costly and lossy. In addition, the accuracy of the search results can be improved by including the image or other media element in the search process.

As a result, once the query response system has received the multimodal input query, the query response system can retrieve a plurality of search results associated with the multimodal input query. In some examples, the query response system can access two or more search systems that produce search results. For example, some search systems can perform image-based searches. Other search systems can produce search results based on textual content. In other examples, search systems can include both text and images to identify documents associated with the query.

The query response system can receive search results from a plurality of search systems. In some examples, the search results received from the plurality of search systems are ranked. The query response system can generate a combined list of search results ranked in order of relevance to the multimodal input query. The search results can be ranked, at least in part, based on the prominence of one or more images included in the search result.

The query response system can select a predetermined number of search results from the ranked search results to score for relevance to the multimodal input query. The relevance score can be generated by a visual language model that can take both text and images as input.

The visual language model can be trained to generate a relevance score for a particular document (or portion of a document).

In some examples, each search result includes a plurality of sections or passages. For example, each search result can be segmented into passages of a fixed block size. Each passage in a particular search result can receive a relevance score. In other examples, the query response system can generate a block or passage from a document by stepping through the document to extract a plurality of passages of a fixed length. For example, if a document includes one hundred words and the passage size is 25 words long, the query search system can first consider the first 25 words of the document. Once the first passage is scored, the query can step the block forward to consider the second through twenty-sixth words within a document. This process can be repeated until the entire document and all possible blocks have been considered.

In some examples, the query response system can extract passages (e.g., blocks of text) based on the location and size of a relevant image in the document. For example, the search result (e.g., a document) can include a relevant image. The text before, after, and around the image can be extracted and provided to the passage scoring system. The query response system can provide a respective passage, and the multimodal input query can be used as input to the passage scoring system. The passage scoring system can output a relevance score for the respective passage. In some examples, the passage scoring system can generate relevance scores for a predetermined number of passages.

In some examples, the relevance score can be based on the content of the text and the images in the passage. The relevance score can be determined based, at least in part, on the proximity of the passage to one or more images that are relevant to the multimodal input query. For example, if a particular document is retrieved because it includes an image that matches the image from the multimodal input query, passages extracted from that document can be ranked or scored, at least partially, on how close the passage is to the matching image. Thus, passages located near to the matching image can receive a higher score than passages that are not located near (e.g., with the document) to the matching image.

Once relevance scores have been generated for a plurality of passages, the query response system can select a predetermined number of passages based on their respective relevance scores. For example, the query response system can choose the ten passages with the highest relevance scores. In some examples, the number of passages selected can be determined based on the size of the passage, the size of the input window of the response generation model, and any combination of the two.

Once the predetermined number of passages has been selected, the query response system can generate a model input that includes the selected passages and the input query. This model input can be a prompt. The prompt can be provided to a response generation system. The response generation system can generate an output based on the context provided by the selected passages. The response generation model can generate model output based on the model input. The model output can include a natural language explanation of a response for the input query.

The natural language response can be transmitted to a user computing device associated with a user. In some examples, the model output can be transmitted to a user computing device along with a list of search results. The list of search results can be the same search results that were retrieved by the query response system or a different set of search results generated by a separate search system. The model output can be displayed in a web page along with a plurality of search results. For example, the model output can be displayed in an interface element box above the other search results. The model response can include a summary of the information included in the selected passages.

The systems and methods of the present disclosure provide a number of technical effects and benefits. As one example, the systems and methods can reduce the latency and the amount of computation resources needed to generate an accurate response to a multimodal input query. Automatically and accurately identifying supporting contextual passages for a multimodal input query can significantly reduce the time and cost needed to produce accurate results for a machine-learned model.

Another example of technical effect and benefit relates to improved computational efficiency and improvements in the functioning of a computing system. For example, a technical benefit of the systems and methods of the present disclosure is the ability to reduce the computational resources needed to convert images (and other media elements) into a text representation. Omitting this step to search using images directly reduces the query response system's power usage and processor usage.

With reference now to the Figures, example embodiments of the present disclosure will be discussed in further detail.

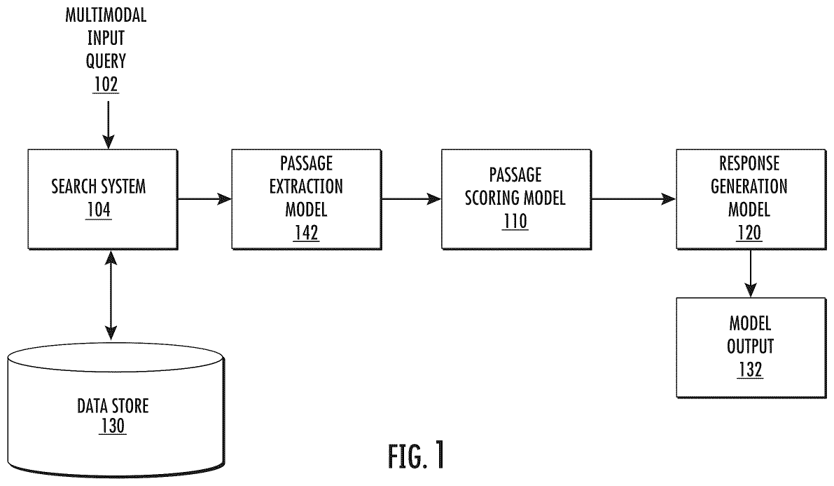

FIG. 1 represents an example of a system for selecting passages as context for a generative model in response to a multimodal input query in accordance with example embodiments of the present disclosure. In this example, a query response system can receive a multimodal input query 102. The multimodal input query 102 can include two or more types of content. For example, the two or more types of content can include textual content and/or one or more media elements. The media elements can include image content, video content, audio content, interactive content, etc. The multimodal input query 102 can be included in a prompt provided to the query response system as input. The query response system can be trained to provide a model output based on the multimodal input query 102.

The multimodal input query 102 can be provided to a search system 104. The search system 104 can be configured to generate a plurality of search results based on the multimodal input query 102. The search system 104 can access a data store 130 to generate search results. In some examples, the search system 104 can generate one or more sub-searches to generate a plurality of search results from a variety of potential data sources. In some examples, the sub-searches can include an image search that uses an image included in the multimodal input query to search an image database for similar images. In some examples, each image in the database of images can be associated with one or more documents. The image search can then return a series of documents (or search results) that include images that are determined to be similar to the image included in the multimodal input query 102.

In another example, the search system 104 can access a text-based search system. The text-based search system can search a database of documents based on the textual content of the multimodal input. In some examples, the text-based system can use a machine-learned model to generate a description of any media elements included in the multimodal input query. If so, that description can also be used by the text-based search system to identify relevant search results. In addition, a multimodal search system can use both the images and the text included in a multimodal input query to generate search results from a database of multimodal documents.

In some examples, each subquery or sub-search can result in a plurality of search results being returned to the search system. In some examples, the returned search results can be ranked by the system that performed the search. The search results can be ranked based on the degree to which they are associated with or answer the query posed in the multimodal input query. The search system 104 can combine the search results from the plurality of subsystems that provided the search. In some examples, the combined list of search results can be ranked or ordered based on the degree to which the search results are determined to be responsive to or otherwise relevant to the multimodal input query.

Once the search results have been ranked, the search system 104 can select a plurality of search results based on the ranking. The search system 104 can select a predetermined number of passages to reduce the total number of passages that need to be scored. In some examples, the number of selected search results can be predetermined based on one or more factors. In another example, the number of selected search results can be a percentage of the number of search results. In yet other examples, the search system 104 can select any search result that exceeds a predetermined ranking value. The search system 104 can extract one or more passages from the selected search results. For example, a passage can be a portion of text of a predefined size. In some examples, each search result includes a plurality of passages, and the search system 104 can extract each passage from the search result.

The search system 104 can provide each passage extracted from a search result to the passage scoring model 110. The passage scoring model 110 can be a machine-learned model trained to take a multimodal input query and a passage of text as input and provide a relevance score for the passage as output. The relevance score can be based on the degree to which it is relevant to the multimodal input query 102. In some examples, each passage can be scored by the passage scoring model 110 based on the content in the passage and the multimodal input query 102. In some examples, the relevance score of each passage can be based on the content of the passage, the degree to which it matches the multimodal input query, the proximity of the passage to one or more images determined to be similar to an image included in the multimodal input query, the quality of the match between the multimodal input query and the document from which the passage is extracted, and any other relevant factor.

Once all the passages have been scored, the query response system can select the highest-scoring passages. In some examples, the selected passages can be determined based on a raw relevance score. In an alternative example, the query response system can select passages that cover a wide variety of topics. For example, if a potential response covers three factual points, the query response system can ensure that at least one passage associated with each point can be selected. Doing so prevents selecting passages that are all directed towards a single aspect of a query response.

In some examples, the number of passages selected can be based on the size of an input window to a response generation model 120. For example, if a passage has a particular size and the multimodal input query (and other context data for the multimodal input query) takes a specific amount of space, the amount of remaining space can be subdivided by the size of the passages to determine the number of passages that can be supplied as context to a multimodal input query 102. In some examples, the passage-scoring model can select a predetermined number of relevant passages. For example, the passage-scoring model can select the ten most relevant passages. Once the passages have been selected based on their relevance score, an input generation system can generate a model input for a response generation model 120. The model input can include the multimodal input query 102, the number of selected passages as context, and any contextual information necessary to provide a satisfactory response to the multimodal input query 102.

Once the input generation system has generated a model input, the model input can be provided to the response generation model 120. The response generation model 120 can be a sequence processing model that takes a model input and generates a model output 132. The model output 132 can be a natural language response to the multimodal input query 102. In some examples, the model output 132 can include a summary of the information included in the selected passages. Thus, the model output 132 can include a general overview of information necessary to respond to the multimodal input query 102.

Once the model output 132 has been generated, the query response system can provide the output to a computing device associated with the user who submitted the multimodal input query. For example, the model can be transmitted over a computer communication network to the requesting user's computing device and displayed to the user. In some examples, the model output can be displayed on a page of web search results.

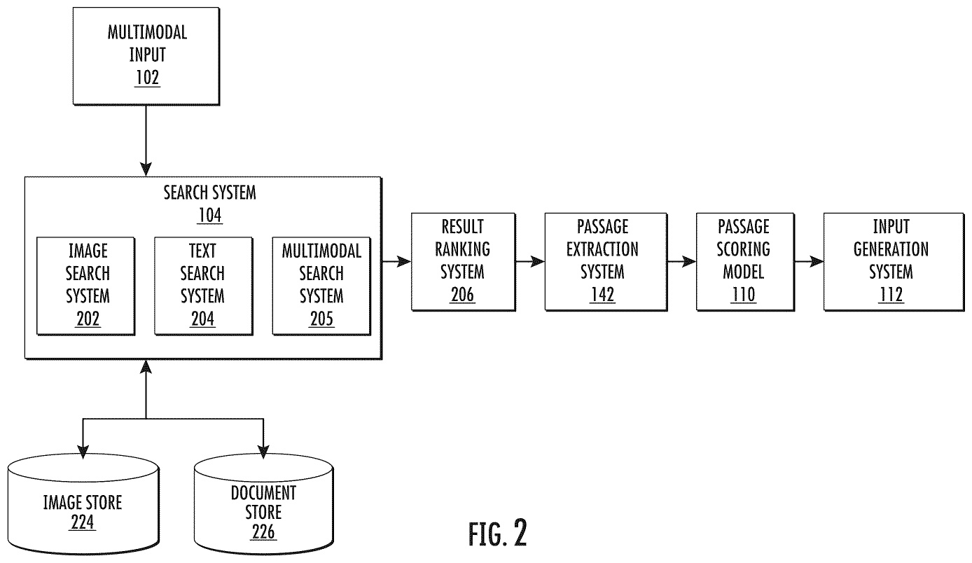

FIG. 2 depicts a query response system in accordance with example embodiments of the present disclosure. FIG. 2 illustrates more details of portions of the query response system depicted in FIG. 1. In this example, the query response system includes a search system 104, a result ranking system 206, a passage extraction system 142, a passage scoring model 110, and an input generation system 112. As discussed above in FIG. 1, the query response system can receive a multimodal input query 102. The multimodal input query 102 can include two or more types of content. The types of content can include textual content, image content, video content, audio content, interactive content, and so on. For example, the multimodal input query 102 can include a text question and one or more images. In some examples, the text portion can be a question about one of the images or a reference to one of the images.

The query response system can provide the multimodal input query 102 to a search system 104. The search system 104 can generate a list of search results based on the multimodal input query 102. The search system 104 can employ a variety of different search subsystems to generate search results. For example, the search system 104 can include or access an image search system 202, a text search system 204, a multimodal search system 205, or some combination to retrieve relevant search results for the multimodal input query 102.

In some examples, an image search system 202 can use an image included in the multimodal input query 102 to identify similar images in a database of images in image store 224. In some examples, the image can be processed to generate an embedded representation of the image. The embedded representation can then be compared against a plurality of stored embedded representations of images in the image store 224. For each embedded image in the image store 224, the image search system 202 can determine a similarity to the embedded image. In some examples, any embedded image in the image store 224 that has a similarity score above a threshold score value can be determined to match the embedded image from the multimodal input query 102. Each embedded image in the image store 224 can be associated with one or more documents. For example, each document can represent a web page that includes the image and is accessible over the Internet.

In some examples, the multimodal input query 102 can include a video. In that case, the image search system 202 can perform a search of a video database. To do so, the image search system 202 can embed each image in the video or embed the video as a whole. The embedded frames (or full video) can be compared to the embedded videos stored in the video database.

For each respective image in the image store 224 determined to match (e.g., meet the similarity criteria) the embedded image from the multimodal input query 102, the image search system 202 can access all associated documents that include the respective image. These documents can be returned to the search system 104 as search results. In some examples, the returned search results can be ranked based on the degree to which the included image matches the image from the multimodal image query and the prominence of the image within the document. For example, if a particular image in the image store 224 has a high match score with the embedded image from the multimodal input query 102, documents that include the particular image will be ranked higher than documents that include an image that has a lower match score. Similarly, for a particular image, documents that prominently display that particular image will be ranked higher than documents that do not prominently display that particular image. In this way, all the documents that were returned as search results by the image search system 202 can be ranked from most relevant to least relevant.

The search system 104 can also access a text search system 204. The text search system 204 can use the textual component of the multimodal input query 102 to search a document store 226 for documents that match or are associated with the text portion of the multimodal input query 102. In some examples, any media elements included in the multimodal input query 102 can be converted into a textual representation of the image for use in the text search system 204.

In some examples, a machine-learned model can be trained to generate a text representation of a media element. The textual representation of one or more media elements and the textual content of the multimodal input query 102 can be provided to the text search system 204. In some examples, the text search system 204 can convert the textual content into a series of embedded representations or symbols. The embedded (or symbolic) representation can represent an abstract version of the content of the text. Once the textual content has been converted into embedded space, the text search system 204 can determine whether one or more documents in the document store 226 match the textual content. The text search system 204 can return a plurality of documents from the document store 226 as search results. In some examples, the text search system 204 can return a fixed number of results. In another example, the text search system 204 can return documents that meet a predetermined threshold matching value. In other examples, the text search system 204 can return a number of search results based on the importance of the text relative to the image. For example, if the multimodal input query 102 includes very little text, the number of search results returned by the text search system 204 can be less than the number of search results returned by the image search system 202.

The multimodal search system 205 can be trained to generate an embedded representation of both textual and image content. Once the multimodal content has been converted into an embedded space, the multimodal search system 205 can determine whether one or more documents in the document store 226 match the embedded multimodal content. The multimodal search system 205 can then return a plurality of documents from the document store 226 and/or the image store 224 as search results. In some examples, it can return a fixed number of results.

The search system 104 can receive the search results from the image search system 202, the text search system 204, the multimodal search system 205, and other search systems not depicted herein. Each set of search results from search subsystems can be ranked based on the degree to which each search result matches the multimodal input query 102. The search system 104 can combine the search results into a single set. In some examples, the search system 104 can determine how to weigh the search results from the different search systems based on one or more characteristics of the multimodal input query. For example, the search system 104 can determine the relative importance of the different portions of the multimodal input query and weigh the search results based on that. For example, if an image in the multimodal input query 102 is more important or prominent than the text, the results from the image search system 202 can be ranked more highly than the results from the text search system 204.

In some examples, the search results can be ranked and combined by the result ranking system 206. Once the search results have been ranked, the results ranking system 206 can select a plurality of search results from the total list of search results to provide to the passage extraction system 142. In some examples, the result ranking system 206 can select a predetermined number of search results. In other examples, the result ranking system 206 can determine a threshold ranking value. Any search result that exceeds the threshold ranking value can be provided to the passage extraction system 142. In this way, the total number of search results evaluated by the passage extraction system 142 can be limited to the most relevant documents.

For each search result, the passage extraction system 142 can extract one or more passages. In some examples, each search result can include a plurality of passages. In some examples, passages can be fixed in length. The passage extraction system 142 can extract passages based on the position of one or more images in the document. For example, if a particular image is determined to be relevant to the multimodal input query 102, the passage extraction system 142 can extract passages from the document based on the location of the image within the document. In this way, the passage extraction system 142 can extract the most relevant portions of the document for consideration. In other examples, the entire search result can be partitioned into a plurality of chunks based on the fixed size of the passages. Each chunk can be considered separately.

The passage extraction system 142 can provide each extracted passage to the passage scoring model 110. The passage scoring model 110 can be a machine-learned model that is trained to take a passage and a multimodal input query as input and generate a score based on the degree to which the passage is relevant to the multimodal input query. In this way, the passage scoring model 110 can generate a relevance score for each passage extracted by the passage extraction system 142. In some examples, the relevance score of each passage can be based on the content of the passage, the degree to which it matches the multimodal input query, the proximity of the passage to one or more images determined to be similar, the quality of the match between the multimodal input query and the document from which the passage is extracted, and any other relevant factor.

The input generation system 112 can, based on the scores generated by the passage scoring model 110, determine the most relevant passages from the search results as extracted by the passage extraction system 142. In some examples, the input generation system 112 can select a predetermined number of the most relevant passages. In some examples, the input generation system 112 can select passages based on their relevance score. In other examples, the input generation system 112 can select passages to provide broad coverage of the concepts within the multimodal input query 102. For example, if the multimodal input query 102 is determined to cover three significant topics, the input generation system 112 can select passages that cover all three topics.

The input generation system 112 can generate a model input for a response generation model. The input can include the selected passages. In some examples, ten passages are selected. The number of passages selected can depend on the size of input allowable to the response generation model and the size of each passage. Once the operation system 112 has generated a model input, the model input can be provided to the response generation model. The response generation model can generate a model output (e.g., a natural language query response) based on the model input.

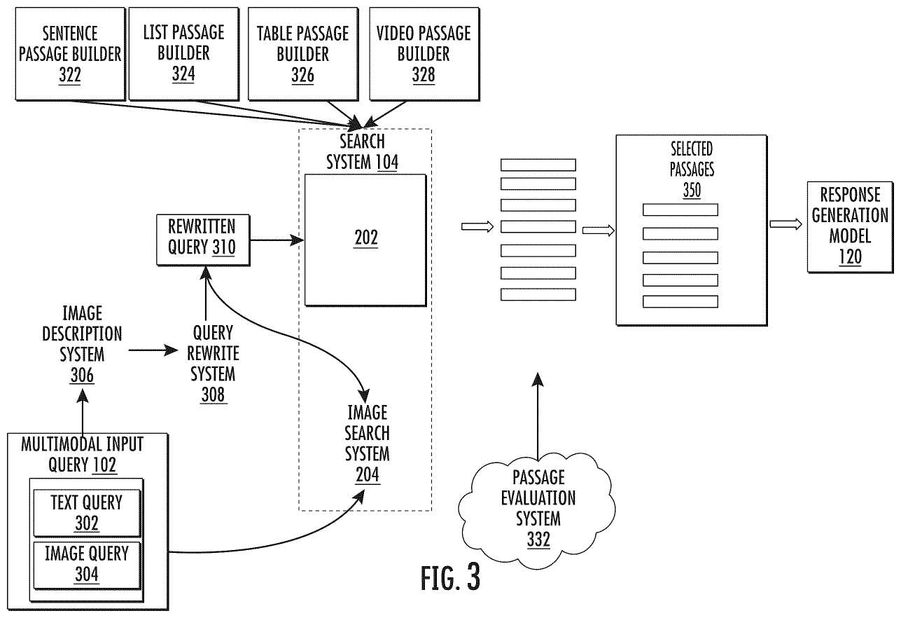

FIG. 3 depicts a query response system in accordance with example embodiments of the present disclosure. In this example, the multimodal input query 102 can include a text portion of the query 302 and an image portion of the query 304. In some examples, the image portion of the query 304 can be provided directly to the image search system 202. In addition, the image portion of the query 304 can be provided to an image description system 306 that extracts context for an image for use in rewriting the query.

The query rewrite system 308 can generate a rewritten query 310 based on the text query and information extracted about the image from the image description system 306. In some examples, the image description system 306 can include a machine-learned model that can produce a written description of an image (or other media element) based on the contents of the image. The query rewrite system 308 can use the information to generate a rewritten query 310. The rewritten query 310 may be rewritten to more accurately describe the query the user has with the context of the image when generating a list of potential search results.

In some examples, the rewritten query 310 can be provided to a series of search providers. The search providers can include a text search system 204 and an image search system 202. In some examples, the search system 104 can access a series of subsystems, including a sentence passage builder 322, a list passage builder 324, a table passage builder 326, and a video passage builder 328 to generate a set of search results.

The set of search results can be provided to the passage evaluation system 332. The passage evaluation system 332 can extract a plurality of passages from the search results. The passage evaluation system 332 can include a passage-scoring model that takes a passage and the multimodal input query 102 as input and outputs a score representing the degree to which the passage provides useful information about the multimodal input query 102. In addition, the passage evaluation system 332 can use a heuristic that ranks the passages based on their score and the diversity of information they provide. For example, suppose several passages all provide the same basic information. In that case, the passage evaluation system 332 can reduce the score of all but one of those passages so that not too many passages provide the same information. This allows for a greater diversity of information to be provided through the passages.

The passage evaluation system can select a predetermined number of passages 350 based on the generate scores or the rankings. Once a predetermined number of passages 350 have been selected based on their score and the diversity of information the provide, the passages can be provided to a response generation model 120 that generates an output based on the multimodal input query, the passages selected for relevance, and contextual information associated with the query. The output of the response generation model 120 can include a natural language description of information associated with the multimodal input query.

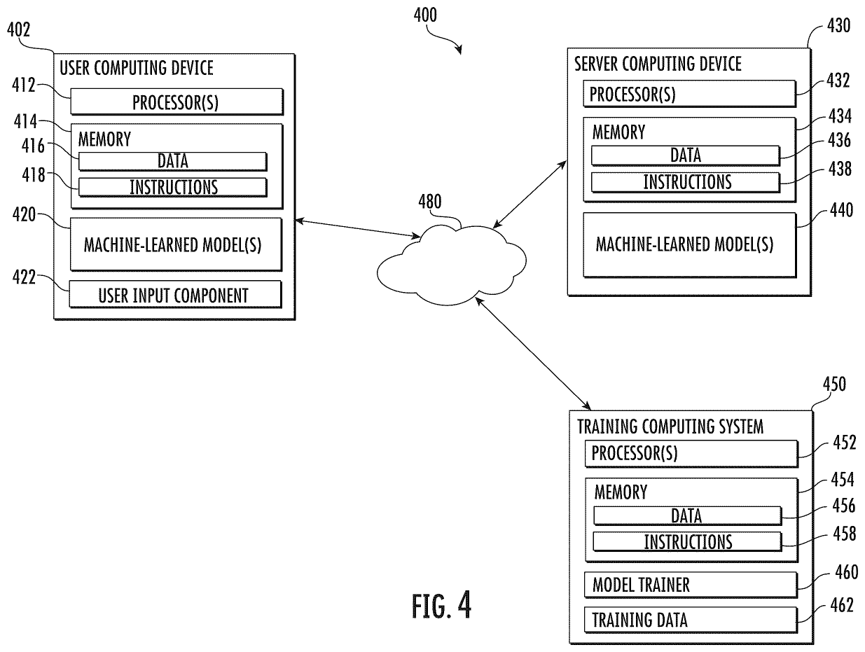

FIG. 4 depicts a block diagram of an example computing system 400 for automatically evaluating the output of machine-learned models for correctness according to example embodiments of the present disclosure. The computing system 400 includes a user computing device 402, a server computing system 430, and a training computing system 450 that are communicatively coupled over a network 480.

The user computing device 402 can be any type of computing device, such as a personal computing device (e.g., laptop or desktop), a mobile computing device (e.g., smartphone or tablet), a gaming console or controller, a wearable computing device, an embedded computing device, or any other type of computing device.

The user computing device 402 includes one or more processors 412 and a memory 414. The one or more processors 412 can be any suitable processing device (e.g., a processor core, a microprocessor, an ASIC, an FPGA, a controller, a microcontroller, etc.) and can be one processor or a plurality of processors that are operatively connected. The memory 414 can include one or more non-transitory computer-readable storage mediums, such as RAM, ROM, EEPROM, EPROM, flash memory devices, magnetic disks, etc., and combinations thereof. The memory 414 can store data 416 and instructions 418, which are executed by the processor 412 to cause the user computing device 402 to perform operations.

The user computing device 402 can also include one or more user input components 422 that receive user input. For example, the user input component 422 can be a touch-sensitive component (e.g., a touch-sensitive display screen or a touchpad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

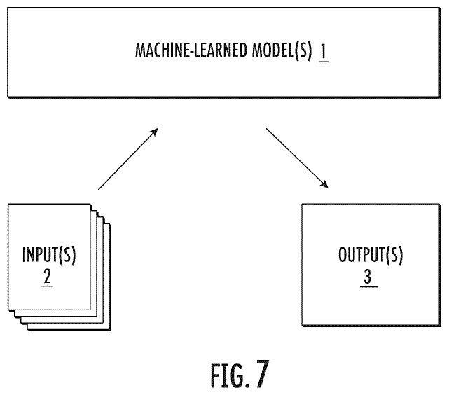

In some implementations, the user computing device 402 can store or include one or more machine-learned models 420 (e.g., a sequence processing model and/or a passage scoring model). For example, the machine-learned models 420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 420 are discussed with reference to FIGS. 7-11.

In some implementations, the one or more machine-learned models 420 can be received from a server computing system 430 over network 480, stored in the memory 414 of the user computing device 402, and then used or otherwise implemented by the one or more processors 412. In some implementations, the user computing device 402 can implement multiple parallel instances of a single machine-learned model 420.

More particularly, the machine-learned model 420 (e.g., a sequence processing model) can respond to multimodal input queries. To do so, a machine-learned model (e.g., a response generation model) can receive a multimodal query. The multimodal query can include textual content and one or more media elements. As discussed above, the media elements can consist of image content, video content, audio content, and interactive content.

A response generation system can process the multimodal input query. Processing the input can include generating a written description of any media elements. A description generation model can be used to receive a media element (e.g., an image) as input and output a written description of the contents of the media element. The description generation model can be a machine-learned model. Based on this description and analysis of the textual content, the system can generate a rewritten query that is more useful when searching for search results.

The multimodal input query (or a rewritten version of the query) can be provided to a search system. The search system can generate a list of search results based on the multimodal input query. In some examples, the search system can access a plurality of subsystems to provide different types of searches and search results. For example, the search system can provide images to an image search system. The image search system can return a list of similar images or documents containing similar images. Similarly, the search system can access a text search system or multimodal search system to perform text or multimodal searches.

In some examples, the image search system can generate an embedded version of an image. An embedded version of an image is a representation of the contents of the image. For example, the embedded image can include a plurality of symbols that represent the contents of the image. Once the image has been embedded, the image search system can compare the image to a plurality of stored embedded images. The stored images represent a database of previously categorized and embedded images.

The search system can determine one or more images that are similar to or associated with the image included in the multimodal input query based on a comparison of the embedded image and the stored embedded images. The image search system can determine a plurality of images that are relevant to the multimodal input query. For each relevant image, the search system can identify one or more documents that include that relevant image. These documents can be returned as search results to the search system. In some examples, each document can be ranked based on the relevance of the image included in the document as well as the prominence of the image within the document. The image search system can select a number of documents based on their relevance scores and provide a ranked list of search results to the search system.

In some examples, the search system can also access a text-based search system. The text-based search system can take the text portion (or a rewritten version thereof) of the multimodal input query as input. In addition, the search system can generate a textual description of the one or more media elements. This description can be used to perform textual searching. In addition, the textual portion of the query can be rewritten based on a variety of factors, including the contents of the media element. The text search system can provide a ranked list of documents as search results to the search system.

The search system can then combine the search results from each search subsystem. In some examples, the number of search results can be weighed based on the relative importance of the image or the text. In other examples, the plurality of search results are combined into one ranking system. Once the plurality of search results has been received, the query response system can extract one or more passages from the search results. The passages can be text passages that include a predetermined number of words. In other examples, passages can include content other than text or have variable word counts.

In some examples, the query response system can step through a document, generating all possible passages of a fixed length. In other examples, a document can be divided into a number of passages based on a fixed passage size. In other examples, the system can extract passages from the text nearest to a relevant image. Thus, the text above, below, or around the image can be extracted for a passage, while other portions of the document may not be extracted.

Once the passages have been extracted from the search documents, the query response system can provide the passages to a passage-scoring model. The passage-scoring model can be trained to take in the multimodal input query and a respective passage. The passage square model can then generate a relevant score for the respective passage. The relevant score can represent the relevance of the passage to the query. In some examples, the passage-scoring model is a visual language model.

In some examples, the relevance score of each passage can be based on the content of the passage, the degree to which it matches the multimodal input query, the proximity of the passage to one or more images determined to be similar to the image in the multimodal input query, the quality of the match between the multimodal input query and the document from which the passage is extracted, and any other relevant factor.

In some examples, a passage scoring model can score the passage based, at least in part, on whether or not it provides information not present in other passages. In some examples, the system can generate an example response to the query (e.g., a golden response) and associate each passage with a particular portion of the example response. In this way, the query response system can enable the passages to be selected that cover a variety of different topics and information. The query response system can avoid selecting a plurality of passages that all cover the same information. Once all the passages have been scored, the response generation model can select a plurality of passages based on the relevance score and the variety of the information supplied. In some examples, the number of passages selected is fixed based on the size of the passage block, the size of input allowable and the amount of additional contextual information included in the model input.

Once the model input has been generated, it can be provided to the response generation model. The response generation model can be a sequence processing model (or other generative large language model) that generates text-based responses to queries in natural language. Thus, a response generation model can produce or generate a model output based on the model input.

In some examples, the model output can be transmitted to a user computing device associated with the user. The model output can include a natural language response that provides information about the multimodal input query. In some examples, the model output can be displayed on a web page above a plurality of search results. In some examples, the search results are the same search results that were used to extract the passages, and in other examples, the displayed search results are distinct from the search results used to extract the passages.

In some examples, the model output can include citation information that describes the source of each piece of information included in the model output. For example, citation information can be provided in the input to the model, where each passage consists of the citation information necessary to define where the passage was extracted from. For example, the citation information can be a web page from which the passage was derived.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage mediums, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices. In instances in which server computing system 430 includes plural server computing devices, such server computing devices can operate according to sequential computing architectures, parallel computing architectures, or some combination thereof.

As described above, the server computing system 430 can store or otherwise include one or more machine-learned models 440 (e.g., a sequence processing model, a scoring model, or other machine-learned models used by a query response system). For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 440 are discussed with reference to FIGS. 7-11.

The computing device 402 and/or a server computing system 430 can train the models 420 and/or 440 via interaction with the training computing system 450, which is communicatively coupled over the network 480. The training computing system 450 can be separate from or a portion of the server computing system.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage mediums, such as RAM, ROM, EEPROM, EPROM, flash memory devices, magnetic disks, etc., and combinations thereof. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that trains the machine-learned models 420 and/or 440 stored at the user computing device 402 and/or the server computing system 430 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained.

In particular, the model trainer 460 can train the passage scoring model and the response generation model based on a set of training data 462. The training data 462 can include, for example, example multimodal input queries and responses, example passages and relevance scores, and so on.

The model trainer 460 includes computer logic utilized to provide desired functionality. The model trainer 460 can be implemented in hardware, firmware, and/or software controlling a general-purpose processor. For example, in some implementations, the model trainer 460 includes program files stored on a storage device, loaded into a memory and executed by one or more processors. In other implementations, the model trainer 460 includes one or more sets of computer-executable instructions that are stored in a tangible computer-readable storage medium such as RAM hard disk or optical or magnetic media.

The network 480 can be any type of communications network, such as a local area network (e.g., intranet), wide area network (e.g., Internet), or some combination thereof and can include any number of wired or wireless links. In general, communication over the network 480 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can include multimodal input queries. The machine-learned model(s) can process any media elements included in the query to generate an output based on a request. As an example, the machine-learned model(s) can process the media data to generate a new media elements by extracting information from the media data and updating or modifying it based on the request.

In some implementations, the input to the machine-learned model(s) of the present disclosure can be text or natural language data. The machine-learned model(s) can process the text or natural language data to generate an output. As an example, the machine-learned model(s) can process the natural language data included in a particular multimodal input query and generate a prompt based on the multimodal input query.

In some implementations, the input to the machine-learned model(s) of the present disclosure can be speech data. The machine-learned model(s) can process the speech data to generate an output. As an example, the machine-learned model(s) can process the speech data to generate a speech recognition output. The output of the speech recognition system can be used as input to the query response model or passage scoring model.

FIG. 4 illustrates one example computing system that can be used to implement the present disclosure. Other computing systems can be used as well. For example, in some implementations, the user computing device 402 can include the model trainer 460 and the training dataset 462. In such implementations, the model(s) 420 can be trained and used locally at the user computing device 402. In some implementations, the user computing device 402 can implement the model trainer 460 to personalize the models 420 based on user-specific data.

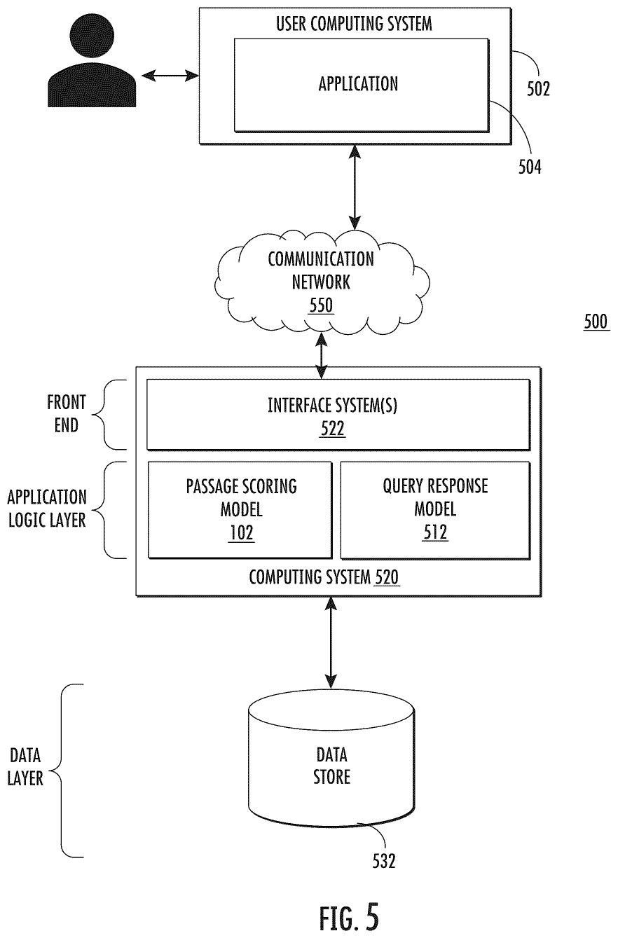

FIG. 5 depicts an example client-server environment 500 according to example embodiments of the present disclosure. The client-server system environment 500 includes one or more user computing systems 502 and a server computing system 520. One or more communication networks 550 can interconnect these components. The one or more communication networks 550 may be any of a variety of network types, including local area networks (LANs), wide area networks (WANs), wireless networks, wired networks, the Internet, personal area networks (PANs), or a combination of such networks.

A user computing system 502 can be one of, but is not limited to, a personal computing system, a smartphone, a smartwatch, a laptop computing device, and a tablet computing system. In some examples, the user computing system 502 can include one or more application(s) 504, such as search applications, communication applications, navigation applications, productivity applications, game applications, word processing applications, or any other applications. The application(s) can include an image based query application. The user computing system 502 can use an image based query application (or other application) to send queries and receive responses to and from the server computing system 520. The user computing system 502 can transmit a query to the server computing system 520. The query can be a multimodal input query. The server computing system 520 can provide the request as part of a prompt to a query response system and provide one or more generated responses (e.g., model output and search results) to the user computing system 502.

As shown in FIG. 5, the server computing system 520 can generally be based on a three-tiered architecture, consisting of a front-end layer, application logic layer, and data layer. As is understood by skilled artisans in the relevant computer and Internet-related arts, each component shown in FIG. 5 can represent a set of executable software instructions and the corresponding hardware (e.g., memory and processor) for executing the instructions. To avoid unnecessary detail, various components and engines that are not germane to conveying an understanding of the various examples have been omitted from FIG. 5. However, a skilled artisan will readily recognize that various additional components, systems, and applications may be used with a server computing system 530, such as that illustrated in FIG. 5, to facilitate additional functionality that is not specifically described herein. Furthermore, the various components depicted in FIG. 5 may reside on a single server computer or may be distributed across several server computers in various arrangements. Moreover, although server computing system 520 is depicted in FIG. 5 as having a three-tiered architecture, the various examples of embodiments are not limited to this architecture.

As shown in FIG. 5, the front end can consist of an interface system(s) 522, which receives communications from a user computing system 502 and communicates appropriate responses to the user computing system 502. For example, the interface system(s) 522 may receive requests in the form of Hypertext Transfer Protocol (HTTP) requests, or other web-based application programming interface (API) requests. The user computing system 502 may be executing conventional web browser applications or applications developed for a specific platform to include any of a wide variety of computing devices and operating systems.

As shown in FIG. 5, the data layer can include a data store 532. The data store 532 can store the data used to produce search results in response to a multimodal input query. In some examples, the data store 532 can represent a plurality of distinct databases, each database storing one type of document. For example, the data store can include a plurality of documents, each indexed and/or embedded into an embedding space to allow for searchability or comparison to an input query. In some examples, the data store 532 (or a database associated with the data store 532) includes a plurality of embedded images. Each embedded image can be related to one or more documents.

When the server computing system 520 receives a multimodal input query, the server computing system 520 (or an associated search system not pictured) can perform a search of the information in the data store 532 (e.g., documents, images, and so on) to determine the most relevant results to the multimodal input query. For example, if the search is an image search, an embedded representation of the search image can be compared to a plurality of stored embedded images. The stored embedded images that are the most similar to the input embedded images can be identified as relevant to the multimodal input query. The server computing system 520 can retrieve one or more documents for each identified embedded image.

These documents can be returned to the passage scoring model 110 as search results. Similarly, a text search can be performed based on textual content included in the multimodal search query or a query that has been rewritten based on the image content in the multimodal input query.

The application logic layer can include application data that provides a wide range of other applications and services, allowing users to submit queries and receive responses. The application logic layer can include a passage scoring model 110 and a response generation model 120.

When a user computing system 502 transmits a multimodal input query to the server computing system 520, the interface system 522 can provide the multimodal input query to the passage scoring model 110 to identify a plurality of relevant passages to the multimodal input query. The relevant passages can be provided, along with the multimodal input query, as input to the response generation model 120.

More specifically, the multimodal input query can be provided to the passage scoring model 110. The passage scoring model 110 can be associated with a search system that can retrieve search results based on the multimodal input query. In some examples, the search system can provide multiple different search methodologies to identify relevant documents. For example, an image search can extract an image from the multimodal input query, embed that image into a representation, and search a database of similarly embedded images to identify similar images. Once a plurality of similar images are identified, the search system can identify documents that contain those similar images. In some examples, a particular image may be present in multiple documents. The documents can be ranked based on the similarity of the included image to the multimodal input query image and the prominence of the image within the document. The ranked documents can be returned to the search system.

Similarly, the search system can provide a text-based search. In some examples, the text-based search can be based on the textual portion of the multimodal input query. In other examples, the system can use them as a model to generate a description of an image included in the multimodal input query. In yet other examples, the textual portion of the multimodal input query can be rewritten based on the image or other media element included in the multimodal input query. The textual search system can generate a representation of the query (e.g., embedded by substituting symbols for aspects of the textual portion) and generate a list of applicable documents based on that representation. The list of documents can be ranked based on their association to the multimodal input query and returned to the search system. The search system can also provide a multimodal search.

Once the system has generated search results from an image search system, a text search system, and any combination of both, the system can combine the search results into a single list. Each search result in the list of search results can be analyzed to determine one or more relevant passages. Each passage can be provided to the passage scoring model 110. The passage-scoring model can generate a relevant score for each passage based on the content of the passage and the contents of the multimodal input query. The highest-scoring passages are determined to be more relevant than the lower-scoring passages.

If multiple passages include the same information, the passage scoring model 110 can automatically reduce the score of some of those passages. Similarly, the score for passages that cover different topics can be increased. In this way, the system can ensure that a broad variety of information is included in the selected passages.

The selected passages can be provided to the response generation model as input. The input can also include the multimodal input query as well as any other contextual information that may be useful, such as past queries, past responses, information provided by the user about themselves, and so on.

The response generation model can accept the input, including the selected passages, the multimodal input query, and any context information. Based on that input, the response generation model can generate an output. The model output can include a natural language response to the input query based at least in part on the image or other media element included in the multimodal input query.

The server computing system 520 can transmit the model output to the user computing system 502 for display. In some examples, the model output can be displayed on a web page with a plurality of other search results. For example, the output is displayed with information about the source of each particular piece of information included in the model output. In this way, the user can verify that the information in the model output is accurate.

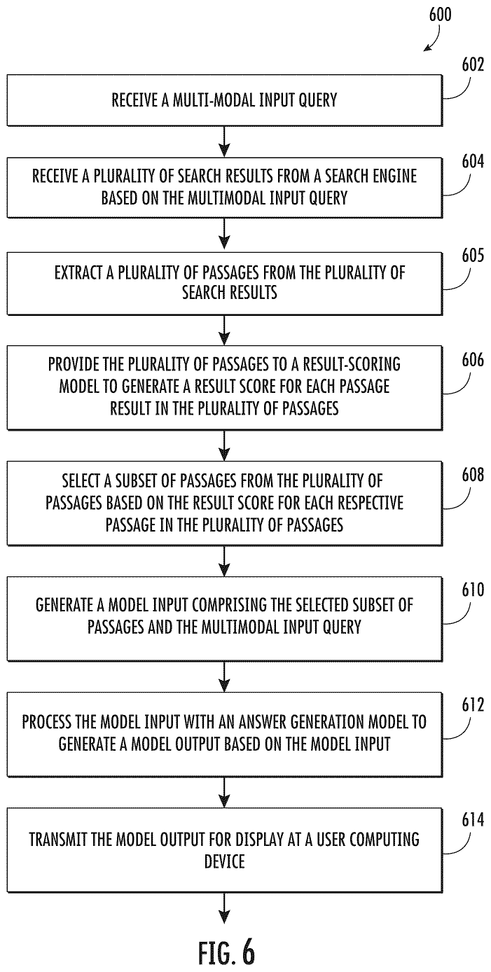

FIG. 6 is a flow diagram representing a process 600 for identifying relevant passages for context to a generative model in accordance with example embodiments of the present disclosure. A computing system with one or more processors can perform a method. The computing system can comprise one or more processors and one or more non-transitory computer-readable media that store instructions. The computing system can include a query response system. The query response system can, at 602, receive a multimodal input query. In some examples, the multimodal input query includes textual content and an image.

The query response system can, at 604, receive a plurality of search results from a search engine based on the multimodal input query. In some examples, the query response system provides the multimodal input query to a plurality of search systems. The query response system can receive preliminary search results from each search system in the plurality of search systems. The query response system can combine the preliminary search results to generate the plurality of search results.

In some examples, the query response system can select a predetermined number of search results to provide to the passage-scoring model, wherein the search results are selected, at least in part, based on their ranking. The plurality of search systems can comprise one or more of: an image search system, a multimodal search system, and a text-based search system.

The search system can be configured to generate, by the computing system, a query embedding based on an image included in the multimodal input query. The search system can be configured to access, by the computing system, a database of embedded images. The search system can be configured to generate, by the computing system, a similarity score for each embedded image in the database of embedded images based on a calculated similarity to the query embedding. The search system can be configured to select, by the computing system, one or more search results to return based on the similarity scores for the plurality of embedded images. In some examples, wherein a respective embedded image is associated with a plurality of search results.

In some examples, a multimodal search system can be configured to generate a query image embedding and a query text embedding based on the multimodal input query. The multimodal search system can be configured to access a database of embedded multimodal documents. The multimodal search system can be configured to generate, by the computing system, a similarity score for each embedded multimodal document in the database of embedded images based on a calculated similarity to the query embedding. The multimodal search system can be configured to select, by the computing system, a plurality of embedded multimodal documents based on the similarity scores to return as search results.

A text-based search system can be configured to generate a textual representation of an image included in the multimodal input query. The multimodal search system can be configured to generate a query text embedding based on the textual representation of the image and a textual portion of the multimodal input query. The multimodal search system can be configured to access a database of embedded documents. A multimodal search system can be configured to generate a similarity score for each embedded document in the database of embedded images based on a calculated similarity to the query text embedding. The multimodal search system can be configured to select a plurality of embedded documents based on the similarity scores to return as search results.

In some examples, generating a textual representation of an image included in the multimodal input query can comprise providing the image to a description generation model for processing. The description generation model can be a machine-learned model that takes an image as input and outputs a text-based description of the image. The response generation model can receive a model output from the description generation model based on the image.

The query response system can, at 605, extract a plurality of passages from the plurality of search results. To do so, the query response system can, for a respective search result in the plurality of search results, segmenting, by the computing system, the respective search results into one or more passages. The query response system further determines a relevance score for each passage in the one or more passages.

The query response system can, at 606, provide the plurality of passages to a passage-scoring model to generate a result score for each respective search result in the plurality of search results. In some examples, the passage-scoring model is a large vision language model. The query response system can, at 608, select a subset of search results from the plurality of search results based on the result score for each respective search result in the plurality of search results. In some examples, the search results are multimodal.

The query response system can add one or more passages to the subset of search results based on the relevance score for each passage. In some examples, the subset of search results includes a predetermined number of search results. In some examples, the predetermined number of search results is 10. Additionally, or alternatively, the number of search results in the sub-set of search results is determined, at least in part, based on a size limit for input to the response generation model.

In some examples, the query response system can, at 610, generate a model input comprising the selected subset of search results and the multimodal input query. In some examples, the model input includes citation data for each search result in the subset of search results. In some examples, the query response system can, at 610, process the model input with a response generation model to generate a model output based on the model input. In some examples, the query response system can, at 614, transmit the model output for display at a user computing device.

In some examples, the model output can comprise a natural language response to the input query. In some examples, the model output can comprise citation data for each search result in the subset of search results provided to the response generation model. Once transmitted to a user computing device, the model output can be displayed on a page of search results.

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of a message generation model. Although various features, variations, and implementations described below are described with respect to machine-learned model(s) 1, it is to be understood that such features, variations, and implementations are to be understood as described with respect to the message generation model, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention.

For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

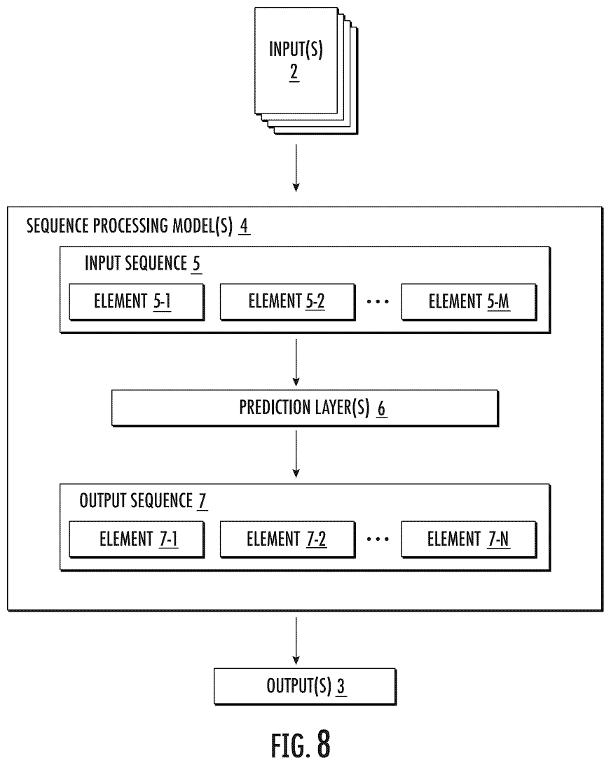

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ____.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

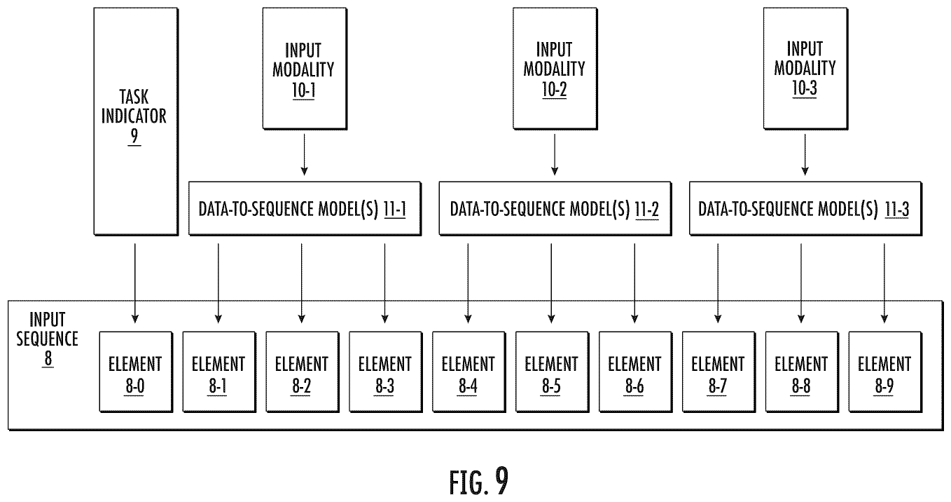

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4.

Data-to-sequence models 11-1, 11-2, and 11-3 can be trained end-to-end with machine-learned sequence processing model(s) 4.

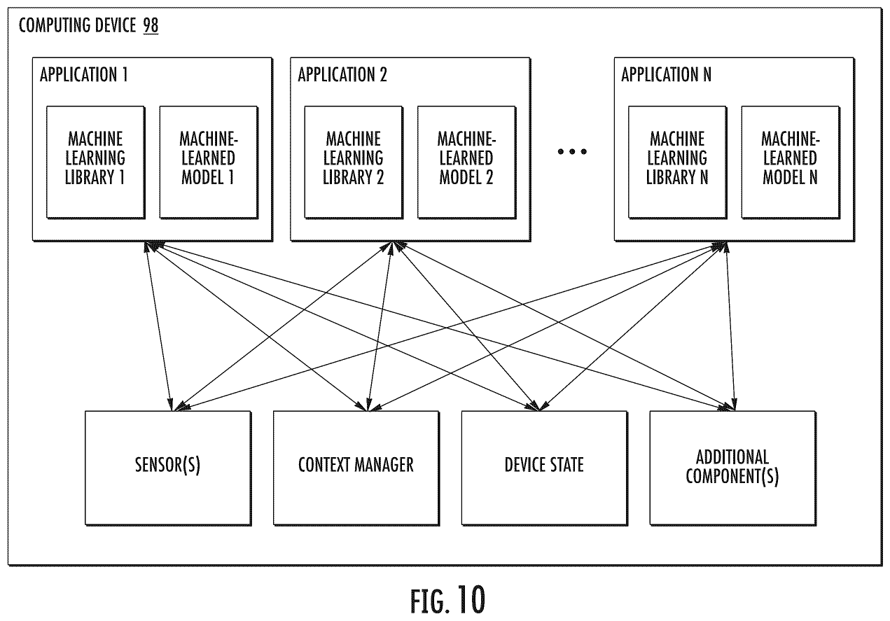

FIG. 10 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine-learned library and machine-learned model(s). For example, each application can include a machine-learned model. Example applications include a text messaging application, an email application, a dictation application, a virtual keyboard application, a browser application, etc. As illustrated in FIG. 10, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

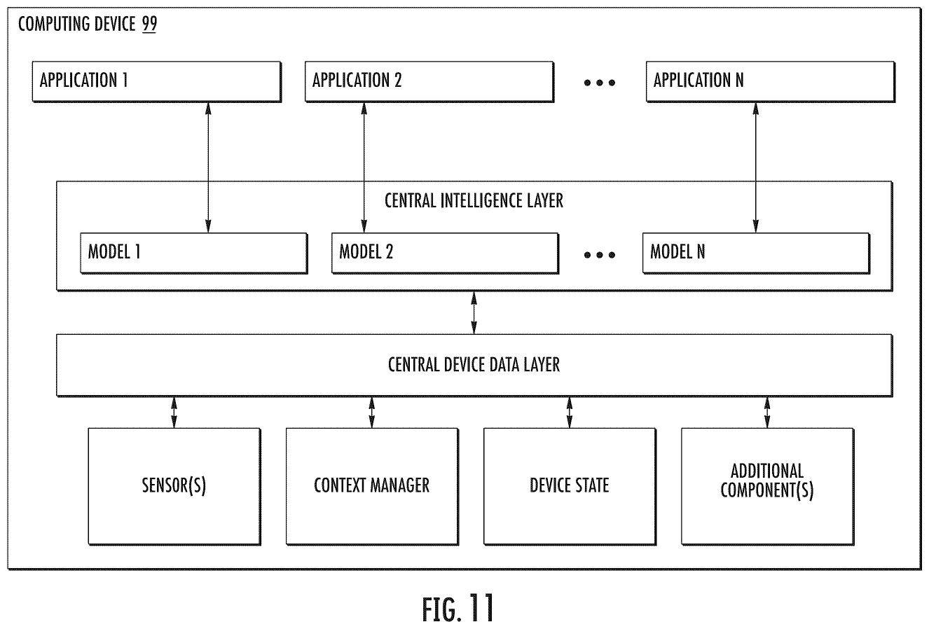

FIG. 11 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 11, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 11, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for processing multimodal input queries, the method comprising:
receiving, by a computing system, a multimodal input query, wherein the multimodal input query comprises image content;
receiving, by the computing system, a plurality of search results from a search engine based on the multimodal input query;
processing, by the computing system, the multimodal input query and the plurality of search results with a passage-scoring model to generate a result score for each respective search result in the plurality of search results, wherein the passage-scoring model comprises a machine-learned multimodal model configured to simultaneously process both the image content from the multimodal input query and textual content from each respective search result to generate the result score for each respective search result;
selecting, by the computing system, a subset of search results from the plurality of search results based on based on the result score for each respective search result in the plurality of search results;
generating, by the computing system, a model input comprising the multimodal input query and the selected subset of search results as context for responding to the multimodal input query;
processing, by the computing system, the model input with a response generation model to generate a model output based on the model input, wherein the model output comprises a natural language response to the multimodal input query; and
transmitting, by the computing system, the natural language response to the multimodal input query for display at a user computing device.

2. The computer-implemented method of claim 1, wherein the multimodal input query includes textual content or speech content.

3. The computer-implemented method of claim 2, wherein receiving, by the computing system, a plurality of search results from a search engine based on the multimodal input query further comprises:
providing, by the computing system, multimodal input query to a plurality of search systems;
receiving, by the computing system, preliminary search results from each search system in the plurality of search systems; and
combining, by the computing system, the preliminary search results into the plurality of search results.

4. The computer-implemented method of claim 1, wherein the plurality of search results are ranked and wherein providing, by the computing system, the plurality of search results to a passage-scoring model to generate a result score for each respective search result in the plurality of search results further comprises:
selecting, by the computing system, a predetermined number of search results to provide to the passage-scoring model, wherein the search results are selected, at least in part, based on their ranking.

5. The computer-implemented method of claim 4, wherein the plurality of search systems comprise one or more of: an image search system, a multimodal search system, and a text-based search system.

6. The computer-implemented method of claim 5, wherein image search system is configured to:
generate, by the image search system, an image query embedding based on an image content included in the multimodal input query;
access, by the image search system, a plurality of embedded images in an image database;
generate, by the image search system, a similarity score for each embedded image in plurality of embedded images based on a calculated similarity to the image query embedding; and
select, by the image search system, one or more search results to return based on the similarity scores for the plurality of embedded images.

7. The computer-implemented method of claim 5, wherein the multimodal search system is configured to:
generate a query image embedding and a query text embedding based on the multimodal input query;
access a database of embedded multimodal documents;
generate a similarity score for each embedded multimodal document in the database of embedded images based on a calculated similarity to the query embedding; and
select a plurality of embedded multimodal documents based on the similarity scores to return as search results.

8. The computer-implemented method of claim 5, wherein the text-based search system is configured to:
generate a textual representation of an image included in the multimodal input query;
generate a query text embedding based on the textual representation of the image and a textual portion of the multimodal input query;
access a database of embedded documents;
generate a similarity score for each embedded document in the database of embedded images based on a calculated similarity to the query text embedding; and
select a plurality of embedded documents based on the similarity scores to return as search results.

9. The computer-implemented method of claim 8, wherein generating a textual representation of an image included in the multimodal input query comprises:
providing, by the computing system, the image to a description generation for processing; and
receiving, by the computing system, a model output from the description generation based on the image.

10. The computer-implemented method of claim 1, wherein the passage-scoring model is a large vision language model.

11. The computer-implemented method of claim 1, wherein the model output comprises a natural language response to the input query.

12. The computer-implemented method of claim 1, wherein the model input includes citation data for each search result in the subset of search results.

13. The computer-implemented method of claim 1, wherein the model output comprises citation data for each search result in the subset of search results provided to the response generation model.

14. The computer-implemented method of claim 1, wherein the model output is displayed on a page of search results.

15. The computer-implemented method of claim 1, wherein the search results are multimodal.

16. The computer-implemented method of claim 1, wherein selecting, by the computing system, a subset of search results from the plurality of search results based on based on the result score for each respective search result in the plurality of search results further comprises:
for a respective search result in the plurality of search results:
segmenting, by the computing system, the respective search results into one or more passages;
determining, by the computing system, a relevance score for each passage in the one or more passages; and
adding, by the computing system, one or more passages to the subset of search results based on the relevance score for each passage.

17. The computer-implemented method of claim 16, wherein a number of search results in the subset of search results is determined, at least in part, based on a size limit for input to the response generation model.

18. The computer-implemented method of claim 1, wherein the response generation model is a large vision language model.

19. A computing system, comprising:
one or more processors; and
one or more non-transitory computer-readable media that store instructions wherein, when executed by the one or more processors, the instructions cause the one or more processors to perform operations, the operations comprising:
receiving a multimodal input query, wherein the multimodal input query comprises image content;
receiving a plurality of search results from a search engine based on the multimodal input query;
processing the multimodal input query and the plurality of search results with a passage-scoring model to generate a result score for each respective search result in the plurality of search results, wherein the passage-scoring model comprises a machine-learned multimodal model configured to simultaneously process both the image content from the multimodal input query and textual content from each respective search result to generate the result score for each respective search result;
selecting a subset of search results from the plurality of search results based on based on the result score for each respective search result in the plurality of search results;
generating a model input comprising the multimodal input query and the selected subset of search results as context for responding to the multimodal input query;
processing the model input with a response generation model to generate a model output based on the model input, wherein the model output comprises a natural language response to the multimodal input query; and
transmitting the natural language response to the multimodal input query.

20. One or more non-transitory computer-readable media that collectively store instructions that, when executed by one or more computing devices, cause the one or more computing devices to perform operations, the operations comprising:
receiving a multimodal input query, wherein the multimodal input query comprises image content;
receiving a plurality of search results from a search engine based on the multimodal input query;
processing the multimodal input query and the plurality of search results with a passage-scoring model to generate a result score for each respective search result in the plurality of search results, wherein the passage-scoring model comprises a machine-learned multimodal model configured to simultaneously process both the image content from the multimodal input query and textual content from each respective search result to generate the result score for each respective search result;
selecting a subset of search results from the plurality of search results based on based on the result score for each respective search result in the plurality of search results;
generating a model input comprising the multimodal input query and the selected subset of search results as context for responding to the multimodal input query;
processing the model input with a response generation model to generate a model output based on the model input, wherein the model output comprises a natural language response to the multimodal input query; and
transmitting the natural language response to the multimodal input query.
